(19) United States
(12) Patent Application Publication
(10) Pub. No.: US 2021/0051664 A1
(43) Pub. Date: Feb. 18, 2021

(54) DYNAMIC SPATIAL REUSE

(71) Applicant: QUALCOMM Incorporated, San Diego, CA (US)

(72) Inventors: Abhijit BHATTACHARYA, Bangalore (IN); Arul Durai Murugan PALANIVELU, Bangalore (IN); Mani Bharathi PANDIAN, Santa Clara, CA (US); Rohit KAPOOR, Bangalore (IN)

(21) Appl. No.: 16/944,829

(22) Filed: Jul. 31, 2020

(30) Foreign Application Priority Data
Aug. 13, 2019 (IN) 201941032760

(51) Int. Cl. H04W 72/04; H04W 16/02; H04W 72/08; H04W 52/36; H04L 1/16; H04W 24/10; H04B 17/318

(52) U.S. Cl. CPC H04W 72/0493; H04W 16/02; H04W 72/082; H04W 72/046; H04W 84/12; H04L 1/1621; H04W 24/10; H04B 17/318; H04W 52/367

(57) ABSTRACT

This disclosure provides systems, methods and apparatuses for dynamically enabling or disabling spatial reuse (SR) transmissions from wireless communication devices belonging to a first basic service set (BSS). In some instances, a first wireless communication device receives a plurality of intra-BSS packets from a second wireless communication device associated with the first BSS, determines an average power level of the intra-BSS packets at the first wireless communication device, determines a maximum power level of overlapping basic service set (OBSS) packets associated with one or more OBSSs, determines a signal-to-interference-plus-noise ratio (SINR) of the intra-BSS packets based on the determined average power level of the intra-BSS packets and the determined maximum power level of the OBSS packets, and determines whether to transmit a spatial reuse (SR) packet to the second wireless communication device while detecting OBSS packets on the wireless medium based on the determined SINR relative to a value.

### CROSS-REFERENCE TO RELATED APPLICATIONS

This Patent Application claims priority to India Foreign Patent Application No. 201941032760 entitled “DYNAMIC SPATIAL REUSE” filed on Aug. 13, 2019, which is assigned to the assignee hereof. The disclosure of the prior Application is considered part of and is incorporated by reference in this Patent Application.

### TECHNICAL FIELD

This disclosure relates generally to wireless communication, and more specifically, to spatial reuse (SR) opportunities on a shared wireless medium.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Many wireless networks use random channel access mechanisms to control access to a shared wireless medium. In these wireless networks, wireless devices (including APs and STAs) contend with each other to gain access to the wireless medium. The wireless device that wins the contention operation becomes the owner of a transmission opportunity (TXOP) and may use the wireless medium for a duration of the TXOP. Other wireless devices are generally not permitted to transmit during the TXOP, for example, to prevent interference with transmissions from the TXOP owner.

Conventional spatial reuse (SR) techniques allow other wireless devices to transmit packets on the wireless medium during the TXOP, even while the TXOP owner is transmitting, if a power level of the TXOP owner's transmissions received at the other wireless devices is below a certain value. However, due to network conditions (such as the number of wireless devices, the volume of network traffic, or the proximity of the wireless devices), conventional SR techniques may undesirably allow wireless devices to transmit SR packets that ultimately interfere with transmissions from the TXOP owner (examples of “false positives”). Conventional SR techniques also may undesirably restrict wireless devices from transmitting SR packets, even when no interference may occur (examples of “false negatives”).

### SUMMARY

The systems, methods and devices of this disclosure each have several innovative aspects, no single one of which is solely responsible for the desirable attributes disclosed herein.

One innovative aspect of the subject matter described in this disclosure can be implemented as a method for wireless communication. In some implementations, the method may be performed by an apparatus of a first wireless communication device associated with a first basic service set (BSS), and may include receiving, over one or more links of a wireless medium, a plurality of intra-BSS packets from a second wireless communication device associated with the first BSS, determining an average power level of the plurality of intra-BSS packets at the first wireless communication device, determining a maximum power level of one or more overlapping basic service set (OBSS) packets associated with one or more OBSSs, determining a signal-to-interference-plus-noise ratio (SINR) of the plurality of intra-BSS packets based on the determined average power level of the plurality of intra-BSS packets and the determined maximum power level of the OBSS packets, and determining whether to transmit a spatial reuse (SR) packet to the second wireless communication device while detecting a number of OBSS packets on the wireless medium based on the determined SINR relative to a value. In some instances, one or more of the plurality of intra-BSS packets may be an acknowledgement (ACK) frame or a block ACK (BA) frame.

In some implementations, determining whether to transmit the SR packet may include transmitting the SR packet to the second wireless communication device while detecting the number of OBSS packets on the wireless medium based on the determined SINR being greater than the value. In some other implementations, determining whether to transmit the SR packet may include refraining from transmitting the SR packet to the second wireless communication device based on the determined SINR being less than the value. In some instances, the determination whether to transmit the SR packet may be independent of an OBSS packet detect (PD) threshold.

In some implementations, determining the average power level of the intra-BSS packets may include determining a received signal strength indicator (RSSI) value for each packet of the plurality of intra-BSS packets, and determining the average RSSI value for the intra-BSS packets based on the RSSI values determined for at least some of the plurality of intra-BSS packets. In some implementations, determining the SINR may include determining a maximum RSSI value of the RSSI values determined for the one or more OBSS packets, and determining a difference between the average RSSI value determined for the intra-BSS packets and the maximum RSSI value determined for the OBSS packets. In some other implementations, determining the SINR may include identifying RSSI values determined for the one or more OBSS packets that are less than an OBSS packet detect (PD) threshold, determining a maximum RSSI value of the identified RSSI values of the OBSS packets, and determining a difference between the average RSSI value determined for the intra-BSS packets and the maximum RSSI value determined for the OBSS packets.

In some implementations, the method also may include disabling SR opportunities for all wireless communication devices associated with or belonging to the first BSS based on the determined SINR being less than the value, irrespective of a level of OBSS interference on the wireless medium. In some instances, the transmission of the SR packet may at least partially overlap with the transmission of at least one of the number of OBSS packets.

In some implementations, transmitting the SR packet also may include initiating a countdown of a backoff counter associated with a medium access contention operation, continuing the countdown of the backoff counter while detecting the number of OBSS packets on the wireless medium in response to the determined SINR remaining greater than the value, and transmitting the SR packet after completion of the countdown of the backoff counter. In some instances, the method also may include freezing the backoff counter in response to determining that the SINR is less than the value. In some other instances, the method also may include resetting the backoff counter in response to determining that the SINR is less than the value.

In some implementations, the method also may include transmitting a non-SR packet to the second wireless communication device based on an absence of OBSS packets on the wireless medium, and setting a flag in the non-SR packet that indicates to other wireless communication devices associated with the one or more OBSSs to not transmit on the wireless medium for a duration. In some instances, the method also may include providing an instruction in the non-SR packet or in a subsequent management frame for the second wireless communication device to set the flag in one or more packets to be transmitted from the second wireless communication device to the first wireless communication device on the wireless medium.

Another innovative aspect of the subject matter described in this disclosure can be implemented in a first wireless communication device. The first wireless communication device may include at least one modem, at least one processor communicatively coupled with the at least one modem, and at least one memory communicatively coupled with the at least one processor. The at least one memory may store instructions that, when executed by the at least one processor, causes the first wireless communication device to receive, over one or more links of a wireless medium, a plurality of intra-BSS packets from a second wireless communication device associated with the first BSS, determine an average power level of the plurality of intra-BSS packets at the first wireless communication device, determine a maximum power level of one or more overlapping basic service set (OBSS) packets associated with one or more OBSSs, determine a signal-to-interference-plus-noise ratio (SINR) of the plurality of intra-BSS packets based on the determined average power level of the plurality of intra-BSS packets and the determined maximum power level of the OBSS packets, and determine whether to transmit a spatial reuse (SR) packet to the second wireless communication device while detecting a number of OBSS packets on the wireless medium based on the determined SINR relative to a value. In some instances, one or more of the plurality of intra-BSS packets may be an acknowledgement (ACK) frame or a block ACK (BA) frame.

In some implementations, execution of the instructions to determine whether to transmit the SR packet may cause the first wireless communication device to transmit the SR packet to the second wireless communication device while detecting the number of OBSS packets on the wireless medium based on the determined SINR being greater than the value. In some other implementations, execution of the instructions to determine whether to transmit the SR packet may cause the first wireless communication device to refrain from transmitting the SR packet to the second wireless communication device based on the determined SINR being less than the value. In some instances, the determination whether to transmit the SR packet may be independent of an OBSS packet detect (PD) threshold.

In some implementations, execution of the instructions to determine the average power level of the intra-BSS packets may cause the first wireless communication device to determine a received signal strength indicator (RSSI) value for each packet of the plurality of intra-B SS packets, and to determine the average RSSI value for the intra-BSS packets based on the RSSI values determined for at least some of the plurality of intra-BSS packets. In some implementations, execution of the instructions to determine the SINR may cause the first wireless communication device to determine a maximum RSSI value of the RSSI values determined for the one or more OBSS packets, and to determine a difference between the average RSSI value determined for the intra-BSS packets and the maximum RSSI value determined for the OBSS packets. In some other implementations, execution of the instructions to determine the SINR may cause the first wireless communication device to identify RSSI values determined for the one or more OBSS packets that are less than an OBSS packet detect (PD) threshold, to determine a maximum RSSI value of the identified RSSI values of the OBSS packets, and to determine a difference between the average RSSI value determined for the intra-BSS packets and the maximum RSSI value determined for the OBSS packets.

In some implementations, execution of the instructions may further cause the first wireless communication device to disable SR opportunities for all wireless communication devices associated with or belonging to the first BSS based on the determined SINR being less than the value, irrespective of a level of OBSS interference on the wireless medium. In some instances, the transmission of the SR packet may at least partially overlap with the transmission of at least one of the number of OBSS packets.

In some implementations, execution of the instructions to transmit the SR packet may cause the first wireless communication device to initiate a countdown of a backoff counter associated with a medium access contention operation, to continue the countdown of the backoff counter while detecting the number of OBSS packets on the wireless medium in response to the determined SINR remaining greater than the value, and to transmit the SR packet after completion of the countdown of the backoff counter. In some instances, execution of the instructions also may cause the first wireless communication device to freeze the backoff counter in response to determining that the SINR is less than the value. In some other instances, execution of the instructions also may cause the first wireless communication device to reset the backoff counter in response to determining that the SINR is less than the value.

In some implementations, execution of the instructions also may cause the first wireless communication device to transmit a non-SR packet to the second wireless communication device based on an absence of OBSS packets on the wireless medium, and to set a flag in the non-SR packet that indicates to other wireless communication devices associated with the one or more OBSSs to not transmit on the wireless medium for a duration. In some other implementations, execution of the instructions also may cause the first wireless communication device to provide an instruction in the non-SR packet or in a subsequent management frame for the second wireless communication device to set the flag in one or more packets to be transmitted from the second wireless communication device to the first wireless communication device on the wireless medium.

Another innovative aspect of the subject matter described in this disclosure can be implemented as a method for wireless communication. In some implementations, the method may be performed by an apparatus of a first wireless communication device associated with a first basic service set (BSS), and may include receiving, over one or more links of a wireless medium, a plurality of acknowledgement (ACK) or block acknowledgement (BA) frames from a second wireless communication device associated with the first BSS, determining a packet error rate (PER) of the plurality of ACK or BA frames at the first wireless communication device, comparing the determined PER of the plurality of ACK or BA frames with a value, and determining whether to transmit a spatial reuse (SR) packet to the second wireless communication device while detecting a number of overlapping basic service set (OBSS) packets on the wireless medium based on the comparison.

In some implementations, determining whether to transmit the SR packet may include transmitting the SR packet to the second wireless communication device while detecting the number of OBSS packets on the wireless medium based on the determined PER of the plurality of ACK or BA frames being less than the value. In some other implementations, determining whether to transmit the SR packet may include refraining from transmitting the SR packet to the second wireless communication device based on the determined PER of the plurality of ACK or BA frames being greater than the value. In some instances, the determination whether to transmit the SR packet may be independent of an OBSS PD threshold.

Another innovative aspect of the subject matter described in this disclosure can be implemented in a first wireless communication device. The first wireless communication device may include at least one modem, at least one processor communicatively coupled with the at least one modem, and at least one memory communicatively coupled with the at least one processor. The at least one memory may store instructions that, when executed by the at least one processor, causes the first wireless communication device to receive, over one or more links of a wireless medium, a plurality of acknowledgement (ACK) or block acknowledgement (BA) frames from a second wireless communication device associated with the first BSS, determine a packet error rate (PER) of the plurality of ACK or BA frames at the first wireless communication device, compare the determined PER of the plurality of received ACK or BA frames with a value, and determine whether to transmit a spatial reuse (SR) packet to the second wireless communication device while detecting a number of overlapping basic service set (OBSS) packets on the wireless medium based on the comparison.

In some implementations, execution of the instructions to determine whether to transmit the SR packet may cause the first wireless communication device to transmit the SR packet to the second wireless communication device while detecting the number of OBSS packets on the wireless medium based on the determined PER of the plurality of ACK or BA frames being less than the value. In some other implementations, execution of the instructions to determine whether to transmit the SR packet may cause the first wireless communication device to refrain from transmitting the SR packet to the second wireless communication device based on the determined PER of the plurality of ACK or BA frames being greater than the value. In some instances, the determination whether to transmit the SR packet may be independent of an OBSS PD threshold.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2A shows an example protocol data unit (PDU) usable for communications between an access point (AP) and a number of stations (STAs).

FIG. 2B shows an example field in the PDU of FIG. 2A.

FIG. 3A shows an example physical layer (PHY) preamble usable for communications between an AP and each of a number of STAs.

FIG. 3B shows another example PHY preamble usable for communications between an AP and each of a number of stations.

FIG. 3C shows an example signal field that may be carried in a PDU.

FIG. 4 shows an example physical layer convergence protocol (PLCP) protocol data unit (PPDU) usable for communications between an AP and a number of STAs.

FIG. 5 shows a block diagram of an example wireless communication device.

FIG. 6A shows a block diagram of an example AP.

FIG. 6B shows a block diagram of an example STA.

FIG. 7 shows a flowchart illustrating an example operation for wireless communication according to some implementations.

FIG. 8A shows a flowchart illustrating an example operation for wireless communication according to some implementations.

FIG. 8B shows a flowchart illustrating an example operation for wireless communication according to some implementations.

FIG. 8C shows a flowchart illustrating an example operation for wireless communication according to some implementations.

FIG. 9A shows a flowchart illustrating an example operation for wireless communication according to some implementations.

FIG. 9B shows a flowchart illustrating an example operation for wireless communication according to some implementations.

FIG. 10A shows a flowchart illustrating an example operation for wireless communication according to some implementations.

FIG. 10B shows a flowchart illustrating an example operation for wireless communication according to some implementations.

FIG. 10C shows a flowchart illustrating an example operation for wireless communication according to some implementations.

FIG. 11 shows a flowchart illustrating an example operation for wireless communication according to some other implementations.

FIG. 12 shows a flowchart illustrating an example operation for wireless communication according to some other implementations.

FIG. 13 shows a timing diagram illustrating the transmissions of communications according to some implementations.

FIG. 14 shows a block diagram of an example wireless communication device according to some implementations.

FIG. 15 shows a block diagram of an example wireless communication device according to some other implementations.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. The described implementations can be implemented in any device, system, or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, or 5G (New Radio (NR)) standards promulgated by the 3rd Generation Partnership Project (3GPP), among others. The described implementations can be implemented in any device, system, or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO), and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Various implementations relate generally to spatial reuse (SR) techniques. Some implementations more specifically relate to dynamically enabling or disabling SR transmissions from wireless communication devices associated with a first basic service set (BSS) based on a signal-to-interference-plus-noise ratio (SINR) between an average power level of intra-BSS packets received over a wireless medium and a maximum power level of one or more overlapping basic service set (OBSS) packets associated with one or more OBSSs. Other implementations more specifically relate to dynamically enabling or disabling SR transmissions from wireless communication devices associated with the first BSS based on a packet error rate (PER) of one or more acknowledgement (ACK) or block acknowledgement (BA) frames received over the wireless medium from a wireless communication device associated with the first BSS.

In some implementations, a first wireless communication device associated with a first BSS may receive, over one or more links of a wireless medium, a plurality of intra-BSS packets from a second wireless communication device associated with the first BSS. The first wireless communication device may determine an average power level of the plurality of intra-BSS packets at the first wireless communication device, and may determine a maximum power level of one or more OBSS packets associated with one or more OBSSs. In some instances, the average power level of the intra-BSS packets may be based on received signal strength indicator (RSSI) values determined for one or more of the received intra-BSS packets, and the maximum power level of the OBSS packets may be determined based on RSSI values determined for one or more of the detected OBSS packets.

The first wireless communication device may determine a signal-to-interference-plus-noise ratio (SINR) of the intra-BSS packets based on the determined average power level of the intra-BSS packets and the determined maximum power level of the OBSS packets, and may determine whether to transmit data in an SR packet to the second wireless communication device while detecting a number of OBSS packets on the wireless medium based on the determined SINR relative to a value. In some instances, the first wireless communication device may transmit the SR packet to the second wireless communication device while detecting the number of OBSS packets on the wireless medium based on the determined SINR being greater than a value, or may refrain from transmitting the SR packet to the second wireless communication device based on the determined SINR being less than the value.

In some other implementations, the first wireless communication device may receive, over one or more links of the wireless medium, a plurality of ACK or BA frames from the second wireless communication device, and may determine a packet error rate (PER) of the plurality of ACK or BA frames at the first wireless communication device. The first wireless communication device may compare the determined PER of the plurality of received ACK or BA frames with a value, and may determine whether to transmit data in an SR packet to the second wireless communication device while detecting a number of OBSS packets on the wireless medium based on the comparison. In some instances, the first wireless communication device may transmit the SR packet to the second wireless communication device while detecting the number of OBSS packets on the wireless medium based on the determined PER of the ACK or BA frames being less than the value, or may refrain from transmitting the SR packet to the second wireless communication device based on the determined PER of the ACK or BA frames being greater than the value.

Particular implementations of the subject matter described in this disclosure can be implemented to realize one or more of the following potential advantages. By determining whether to transmit SR packets to one or more other wireless communication devices belonging to the same BSS based on the SINR or the PER of one or more intra-BSS packets received over the wireless medium, the first wireless communication device may improve network throughput and medium utilization while eliminating or mitigating the occurrences of false positives or false negatives, for example, as compared with conventional SR techniques. Specifically, conventional SR techniques allow SR transmissions while OBSS packets are detected on the wireless medium if the detected energy of the OBSS packets is less than an OBSS packet detect (PD) threshold level, and may not allow SR transmissions while OBSS packets are detected on the wireless medium if the detected energy of the OBSS packets is greater than (or equal to) the OBSS PD threshold level. As such, these conventional SR techniques may not consider the energy of intra-BSS packets relative to the energy of the OBSS packets or the PER of the intra-BSS packets when determining whether to allow SR opportunities in a particular BSS. Due to various network conditions (such as the number of wireless communication devices sharing the wireless medium, an amount of traffic or congestion on the wireless medium, or the proximity of the wireless communication devices to one another), these conventional SR techniques may allow SR packet transmissions that interfere with the OBSS packets (resulting in false positives), may prevent SR packet transmissions even when the SR packet transmissions would not interfere with the OBSS packets (resulting in false negatives), or both.

Another potential advantage that can be realized by implementations of the subject matter described in this disclosure is that methods, devices, and apparatuses may use various aspects of the SR techniques disclosed herein without any changes or addition to the current release or version of the IEEE 802.11 family of standards for wireless communication. Additionally, methods, devices, and apparatuses may implement one or more of the SR techniques disclosed herein without regard to (such as without changing) rate adaption techniques.

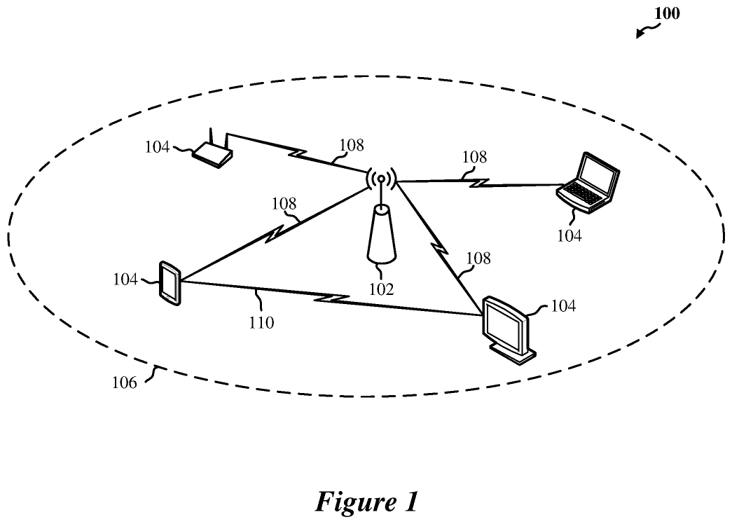

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). The WLAN 100 may include numerous wireless communication devices such as an access point (AP) 102 and multiple stations (STAs) 104. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 108, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 108) according to the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

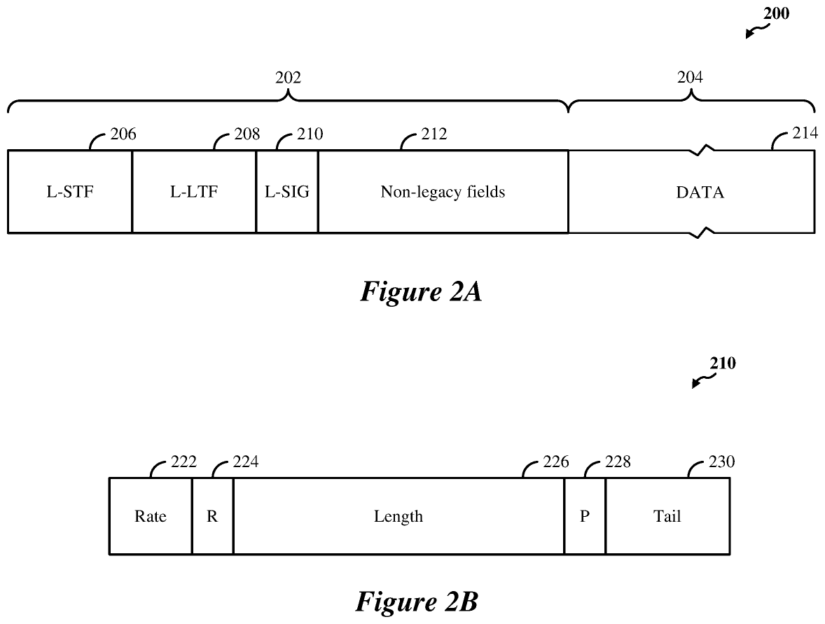

FIG. 2A shows an example protocol data unit (PDU) 200 usable for wireless communication between an AP 102 and one or more STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two BPSK symbols, a legacy long training field (L-LTF) 208, which may consist of two BPSK symbols, and a legacy signal field (L-SIG) 210, which may consist of two BPSK symbols. The legacy portion of the preamble 202 may be configured according to the IEEE 802.11a wireless communication protocol standard. The preamble 202 also may include a non-legacy portion including one or more non-legacy fields 212, for example, conforming to an IEEE wireless communication protocol such as the IEEE 802.11ac, 802.11ax, 802.11be or later wireless communication protocol protocols.

The L-STF 206 generally enables a receiving device to perform automatic gain control (AGC) and coarse timing and frequency estimation. The L-LTF 208 generally enables a receiving device to perform fine timing and frequency estimation and also to perform an initial estimate of the wireless channel. The L-SIG 210 generally enables a receiving device to determine a duration of the PDU and to use the determined duration to avoid transmitting on top of the PDU. For example, the L-STF 206, the L-LTF 208 and the L-SIG 210 may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of medium access control (MAC) protocol data units (MPDUs) or an aggregated MPDU (A-MPDU).

FIG. 2B shows an example L-SIG 210 in the PDU 200 of FIG. 2A. The L-SIG 210 includes a data rate field 222, a reserved bit 224, a length field 226, a parity bit 228, and a tail field 230. The data rate field 222 indicates a data rate (note that the data rate indicated in the data rate field 212 may not be the actual data rate of the data carried in the payload 204). The length field 226 indicates a length of the packet in units of, for example, symbols or bytes. The parity bit 228 may be used to detect bit errors. The tail field 230 includes tail bits that may be used by the receiving device to terminate operation of a decoder (for example, a Viterbi decoder). The receiving device may utilize the data rate and the length indicated in the data rate field 222 and the length field 226 to determine a duration of the packet in units of, for example, microseconds (μs) or other time units.

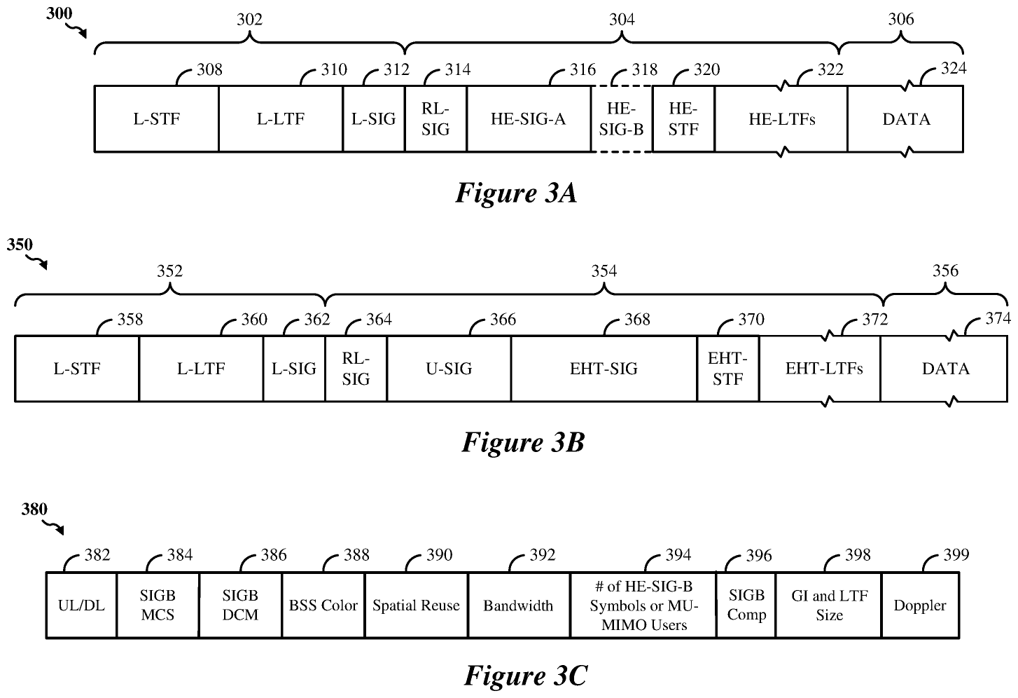

FIG. 3A shows an example PPDU 300 usable for wireless communication between an AP and one or more STAs. The PPDU 300 may be used for SU, OFDMA or MU-MIMO transmissions. The PPDU 300 may be formatted as a High Efficiency (HE) WLAN PPDU in accordance with the IEEE 802.11ax amendment to the IEEE 802.11 wireless communication protocol standard. The PPDU 300 includes a PHY preamble including a legacy portion 302 and a non-legacy portion 304. The PPDU 300 may further include a PHY payload 306 after the preamble, for example, in the form of a PSDU including a data field 324.

The legacy portion 302 of the preamble includes an L-STF 308, an L-LTF 310, and an L-SIG 312. The non-legacy portion 304 includes a repetition of L-SIG (RL-SIG) 314, a first HE signal field (HE-SIG-A) 316, an HE short training field (HE-STF) 320, and one or more HE long training fields (or symbols) (HE-LTFs) 322. For OFDMA or MU-MIMO communications, the second portion 304 further includes a second HE signal field (HE-SIG-B) 318 encoded separately from HE-SIG-A 316. Like the L-STF 308, L-LTF 310, and L-SIG 312, the information in RL-SIG 314 and HE-SIG-A 316 may be duplicated and transmitted in each of the component 20 MHz channels in instances involving the use of a bonded channel. In contrast, the content in HE-SIG-B 318 may be unique to each 20 MHz channel and target specific STAs 104.

RL-SIG 314 may indicate to HE-compatible STAs 104 that the PPDU 300 is an HE PPDU. An AP 102 may use HE-SIG-A 316 to identify and inform multiple STAs 104 that the AP has scheduled UL or DL resources for them. For example, HE-SIG-A 316 may include a resource allocation subfield that indicates resource allocations for the identified STAs 104. HE-SIG-A 316 may be decoded by each HE-compatible STA 104 served by the AP 102. For MU transmissions, HE-SIG-A 316 further includes information usable by each identified STA 104 to decode an associated HE-SIG-B 318. For example, HE-SIG-A 316 may indicate the frame format, including locations and lengths of HE-SIG-Bs 318, available channel bandwidths and modulation and coding schemes (MCSs), among other examples. HE-SIG-A 316 also may include HE WLAN signaling information usable by STAs 104 other than the identified STAs 104.

HE-SIG-B 318 may carry STA-specific scheduling information such as, for example, STA-specific (or “user-specific”) MCS values and STA-specific RU allocation information. In the context of DL MU-OFDMA, such information enables the respective STAs 104 to identify and decode corresponding resource units (RUs) in the associated data field 324. Each HE-SIG-B 318 includes a common field and at least one STA-specific field. The common field can indicate RU allocations to multiple STAs 104 including RU assignments in the frequency domain, indicate which RUs are allocated for MU-MIMO transmissions and which RUs correspond to MU-OFDMA transmissions, and the number of users in allocations, among other examples. The common field may be encoded with common bits, CRC bits, and tail bits. The user-specific fields are assigned to particular STAs 104 and may be used to schedule specific RUs and to indicate the scheduling to other WLAN devices. Each user-specific field may include multiple user block fields. Each user block field may include two user fields that contain information for two respective STAs to decode their respective RU payloads in data field 324.

FIG. 3B shows another example PPDU 350 usable for wireless communication between an AP and one or more STAs. The PPDU 350 may be used for SU, OFDMA or MU-MIMO transmissions. The PPDU 350 may be formatted as an Extreme High Throughput (EHT) WLAN PPDU in accordance with the IEEE 802.11be amendment to the IEEE 802.11 wireless communication protocol standard, or may be formatted as a PPDU conforming to any later (post-EHT) version of a new wireless communication protocol conforming to a future IEEE 802.11 wireless communication protocol standard or other wireless communication standard. The PPDU 350 includes a PHY preamble including a legacy portion 352 and a non-legacy portion 354. The PPDU 350 may further include a PHY payload 356 after the preamble, for example, in the form of a PSDU including a data field 374.

The legacy portion 352 of the preamble includes an L-STF 358, an L-LTF 360, and an L-SIG 362. The non-legacy portion 354 of the preamble includes an RL-SIG 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). One or both of U-SIG 366 and EHT-SIG 368 may be structured as, and carry version-dependent information for, other wireless communication protocol versions beyond EHT. The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). Like L-STF 358, L-LTF 360, and L-SIG 362, the information in U-SIG 366 and EHT-SIG 368 may be duplicated and transmitted in each of the component 20 MHz channels in instances involving the use of a bonded channel. In some implementations, EHT-SIG 368 may additionally or alternatively carry information in one or more non-primary 20 MHz channels that is different than the information carried in the primary 20 MHz channel. EHT-SIG 368 may include one or more jointly encoded symbols and may be encoded in a different block from the block in which U-SIG 366 is encoded. EHT-SIG 368 may be used by an AP to identify and inform multiple STAs 104 that the AP has scheduled UL or DL resources for them. EHT-SIG 368 may be decoded by each compatible STA 104 served by the AP 102. EHT-SIG 368 may generally be used by a receiving device to interpret bits in the data field 374. For example, EHT-SIG 368 may include RU allocation information, spatial stream configuration information, and per-user signaling information such as MCSs, among other examples. EHT-SIG 368 may further include a cyclic redundancy check (CRC) (for example, four bits) and a tail (for example, 6 bits) that may be used for binary convolutional code (BCC). In some implementations, EHT-SIG 368 may include one or more code blocks that each include a CRC and a tail. In some aspects, each of the code blocks may be encoded separately.

EHT-SIG 368 may carry STA-specific scheduling information such as, for example, user-specific MCS values and user-specific RU allocation information. EHT-SIG 368 may generally be used by a receiving device to interpret bits in the data field 374. In the context of DL MU-OFDMA, such information enables the respective STAs 104 to identify and decode corresponding RUs in the associated data field 374. Each EHT-SIG 368 may include a common field and at least one user-specific field. The common field can indicate RU distributions to multiple STAs 104, indicate the RU assignments in the frequency domain, indicate which RUs are allocated for MU-MIMO transmissions and which RUs correspond to MU-OFDMA transmissions, and the number of users in allocations, among other examples. The common field may be encoded with common bits, CRC bits, and tail bits. The user-specific fields are assigned to particular STAs 104 and may be used to schedule specific RUs and to indicate the scheduling to other WLAN devices. Each user-specific field may include multiple user block fields. Each user block field may include, for example, two user fields that contain information for two respective STAs to decode their respective RU payloads.

The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. For example, U-SIG 366 may be used by a receiving device to interpret bits in one or more of EHT-SIG 368 or the data field 374.

FIG. 3C shows an example signal field 380 that may be carried in a WLAN PPDU. In implementations for which the signal field 380 is carried in an HE PPDU, the signal field 380 may be, or may correspond to, a HE-SIG-A field (such as the HE-SIG-A field 316 of the PPDU 300 of FIG. 3A). In implementations for which the signal field 380 is carried in an EHT PPDU, the signal field 380 may be, or may correspond to, an EHT-SIG field (such as the EHT-SIG field 368 of the PPDU 350 of FIG. 3B). The signal field 380 may include an UL/DL subfield 382 indicating whether the PPDU 400 is sent UL or DL, may include a SIGB-MCS subfield 384 indicating the MCS for the HE-SIGB field 412, and may include a SIGB DCM subfield 386 indicating whether or not the HE-SIG-B field 412 is modulated with dual carrier modulation (DCM). The signal field 380 may further include a BSS color field 388 indicating a BSS color identifying the BSS. Each device in a BSS may identify itself with the same BSS color. Thus, receiving a transmission having a different BSS color indicates the transmission is from another BSS, such as an OBSS.

The signal field 380 may further include a spatial reuse subfield 390 indicating whether spatial reuse is allowed during transmission of the corresponding PPDU. The signal field 380 may further include a bandwidth subfield 392 indicating a bandwidth of the PPDU data field, such as 20 MHz, 40 MHz, 80 MHz, 160 MHz, and so on. The signal field 380 may further include a number of HE-SIG-B symbols or MU-MIMO users subfield 394 indicating either a number of OFDM symbols in the HE-SIG-B field 412 or a number of MU-MIMO users. The signal field 380 may further include a SIGB compression subfield 396 indicating whether or not a common signaling field is present, may include a GI+LTF size subfield 398 indicating the guard interval (GI) duration and the size of the non-legacy LTFs. The signal field 380 may further include a doppler subfield 399 indicating whether a number of OFDM symbols in the PPDU data field is larger than a signaled midamble periodicity plus one, and the midamble is present, or that the number of OFDM symbols in the PPDU data field data field 418 is less than or equal to the signaled midamble periodicity plus 1, that the midamble is not present, but that the channel is fast varying.

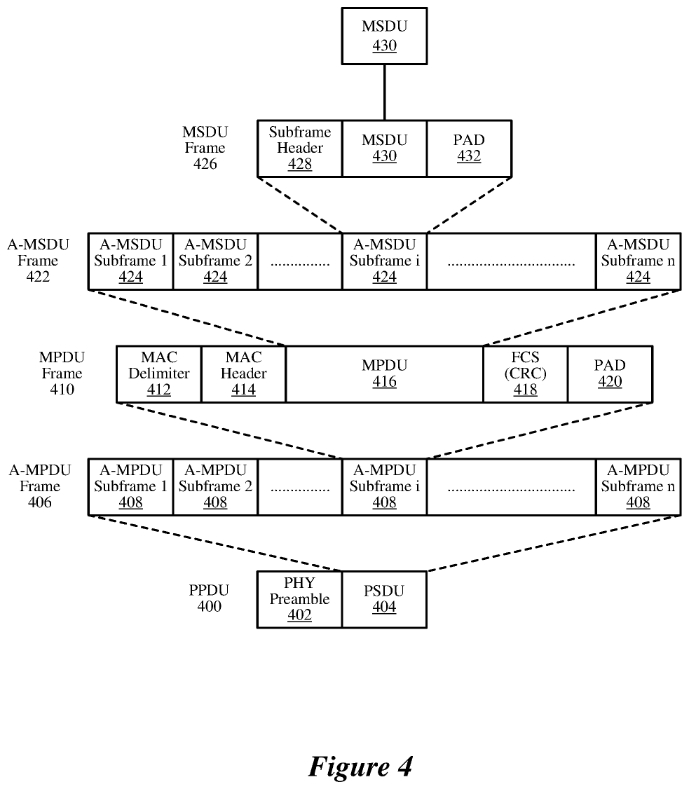

FIG. 4 shows an example PPDU 400 usable for communications between an AP 102 and one or more STAs 104. As described above, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it must wait for a particular time and then contend for access to the wireless medium. In some implementations, the wireless communication device may be configured to implement the DCF through the use of carrier sense multiple access (CSMA) with collision avoidance (CA) (CSMA/CA) techniques and timing intervals. Before transmitting data, the wireless communication device may perform a clear channel assessment (CCA) and determine that the appropriate wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy. Virtual carrier sensing is accomplished via the use of a network allocation vector (NAV), an indicator of a time when the medium may next become idle. The NAV is reset each time a valid frame is received that is not addressed to the wireless communication device. The NAV effectively serves as a time duration that must elapse before the wireless communication device may contend for access even in the absence of a detected symbol or even if the detected energy is below the relevant threshold.

As described above, the DCF is implemented through the use of time intervals. These time intervals include the slot time (or “slot interval”) and the inter-frame space (IFS). The slot time is the basic unit of timing and may be determined based on one or more of a transmit-receive turnaround time, a channel sensing time, a propagation delay and a MAC processing time. Measurements for channel sensing are performed for each slot. All transmissions may begin at slot boundaries. Different varieties of IFS exist including the short IFS (SIFS), the distributed IFS (DIFS), the extended IFS (EIFS), and the arbitration IFS (AIFS). For example, the DIFS may be defined as the sum of the SIFS and two times the slot time. The values for the slot time and IFS may be provided by a suitable standard specification, such as one of the IEEE 802.11 family of wireless communication protocol standards (such as that defined by the IEEE 802.11-2016 specification or amendments thereof including, but not limited to, 802.1lay, 802.11ax, 802.11az, 802.11ba and 802.11be).

When the NAV reaches 0, the wireless communication device performs the physical carrier sensing. If the channel remains idle for the appropriate IFS (for example, the DIFS), the wireless communication device initiates a backoff timer, which represents a duration of time that the device must sense the medium to be idle before it is permitted to transmit. The backoff timer is decremented by one slot each time the medium is sensed to be idle during a corresponding slot interval. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has won contention for the wireless medium. If, on the other hand, one or more of the carrier sense mechanisms indicate that the channel is busy, a MAC controller within the wireless communication device will not permit transmission.

Each time the wireless communication devices generates a new PPDU for transmission in a new TXOP, it randomly selects a new backoff timer duration. The available distribution of the numbers that may be randomly selected for the backoff timer is referred to as the contention window (CW). If, when the backoff timer expires, the wireless communication device transmits the PPDU, but the medium is still busy, there may be a collision. Additionally, if there is otherwise too much energy on the wireless channel resulting in a poor signal-to-noise ratio (SNR), the communication may be corrupted or otherwise not successfully received. In such instances, the wireless communication device may not receive a communication acknowledging the transmitted PDU within a timeout interval. The MAC may then increase the CW exponentially, for example, doubling it, and randomly select a new backoff timer duration from the CW before each attempted retransmission of the PPDU. Before each attempted retransmission, the wireless communication device may wait a duration of DIFS and, if the medium remains idle, then proceed to initiate the new backoff timer. There are different CW and TXOP durations for each of the four access categories (ACs): voice (AC_VO), video (AC_VI), background (AC_BK), and best effort (AC_BE). This enables particular types of traffic to be prioritized in the network.

Some APs and STAs may be configured to implement spatial reuse techniques. For example, APs and STAs configured for communications using IEEE 802.11ax or 802.11be may be configured with a BSS color. APs associated with different BSSs may be associated with different BSS colors. If an AP or a STA detects a wireless packet from another wireless communication device while contending for access, the AP or STA may apply different contention parameters based on whether the wireless packet is transmitted by, or transmitted to, another wireless communication device within its BSS or from a wireless communication device from an overlapping BSS (OBSS), as determined by a BSS color indication in a preamble of the wireless packet. For example, if the BSS color associated with the wireless packet is the same as the BSS color of the AP or STA, the AP or STA may use a first received signal strength indication (RSSI) detection threshold when performing a CCA on the wireless channel. However, if the BSS color associated with the wireless packet is different than the BSS color of the AP or STA, the AP or STA may use a second RSSI detection threshold in lieu of using the first RSSI detection threshold when performing the CCA on the wireless channel, the second RSSI detection threshold being greater than the first RSSI detection threshold. In this way, the requirements for winning contention are relaxed when interfering transmissions are associated with an OBSS.

As described above, APs 102 and STAs 104 can support multi-user (MU) communications including concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from corresponding STAs 104 to an AP 102). To support the MU transmissions, the APs 102 and STAs 104 may utilize multi-user multiple-input, multiple-output (MU-MIMO) and multi-user orthogonal frequency division multiple access (MU-OFDMA) techniques.

In MU-OFDMA schemes, the available frequency spectrum of the wireless channel may be divided into multiple resource units (RUs) each including a number of different frequency subcarriers (“tones”). Different RUs may be allocated or assigned by an AP 102 to different STAs 104 at particular times. The sizes and distributions of the RUs may be referred to as an RU allocation. In some implementations, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Larger 52 tone, 106 tone, 242 tone, 484 tone and 996 tone RUs also may be allocated. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL MU-OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

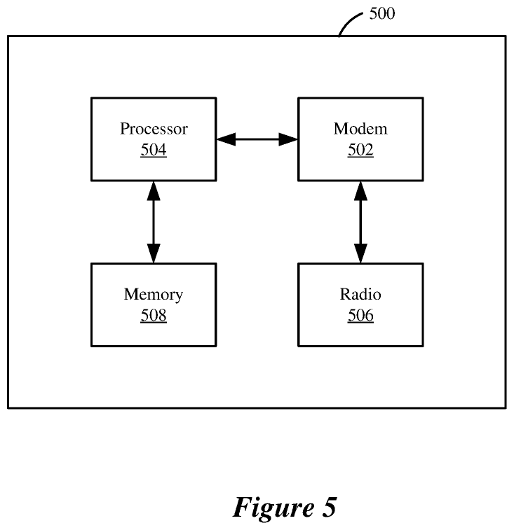

FIG. 5 shows a block diagram of an example wireless communication device 500. In some implementations, the wireless communication device 500 can be an example of a device for use in a STA such as one of the STAs 104 described above with reference to FIG. 1. In some implementations, the wireless communication device 500 can be an example of a device for use in an AP such as the AP 102 described above with reference to FIG. 1. The wireless communication device 500 is capable of transmitting and receiving wireless communications in the form of, for example, wireless packets. For example, the wireless communication device can be configured to transmit and receive packets in the form of physical layer convergence protocol (PLCP) protocol data units (PPDUs) and medium access control (MAC) protocol data units (MPDUs) conforming to an IEEE 802.11 wireless communication protocol standard, such as that defined by the IEEE 802.11-2016 specification or amendments thereof including, but not limited to, 802.11ay, 802.11ax, 802.11az, 802.11ba and 802.11be.

The wireless communication device 500 can be, or can include, a chip, system on chip (SoC), chipset, package or device that includes one or more modems 502, for example, a Wi-Fi (IEEE 802.11 compliant) modem. In some implementations, the one or more modems 502 (collectively “the modem 502”) additionally include a WWAN modem (for example, a 3GPP 4G LTE or 5G compliant modem). In some implementations, the wireless communication device 500 also includes one or more processors, processing blocks or processing elements 504 (collectively “the processor 504”) coupled with the modem 502. In some implementations, the wireless communication device 500 additionally includes one or more radios 506 (collectively “the radio 506”) coupled with the modem 502. In some implementations, the wireless communication device 500 further includes one or more memory blocks or elements 508 (collectively “the memory 508”) coupled with the processor 504 or the modem 502.

The modem 502 can include an intelligent hardware block or device such as, for example, an application-specific integrated circuit (ASIC), among other examples. The modem 502 is generally configured to implement a PHY layer, and in some implementations, also a portion of a MAC layer (for example, a hardware portion of the MAC layer). For example, the modem 502 is configured to modulate packets and to output the modulated packets to the radio 506 for transmission over the wireless medium. The modem 502 is similarly configured to obtain modulated packets received by the radio 506 and to demodulate the packets to provide demodulated packets. In addition to a modulator and a demodulator, the modem 502 may further include digital signal processing (DSP) circuitry, automatic gain control (AGC) circuitry, a coder, a decoder, a multiplexer and a demultiplexer. For example, while in a transmission mode, data obtained from the processor 504 may be provided to an encoder, which encodes the data to provide coded bits. The coded bits may then be mapped to a number N_{SS} of spatial streams for spatial multiplexing or a number N_{STS} of space-time streams for space-time block coding (STBC). The coded bits in the streams may then be mapped to points in a modulation constellation (using a selected MCS) to provide modulated symbols. The modulated symbols in the respective spatial or space-time streams may be multiplexed, transformed via an inverse fast Fourier transform (IFFT) block, and subsequently provided to the DSP circuitry (for example, for Tx windowing and filtering). The digital signals may then be provided to a digital-to-analog converter (DAC). The resultant analog signals may then be provided to a frequency upconverter, and ultimately, the radio 506. In implementations involving beamforming, the modulated symbols in the respective spatial streams are precoded via a steering matrix prior to their provision to the IFFT block.

While in a reception mode, the DSP circuitry is configured to acquire a signal including modulated symbols received from the radio 506, for example, by detecting the presence of the signal and estimating the initial timing and frequency offsets. The DSP circuitry is further configured to digitally condition the signal, for example, using channel (narrowband) filtering and analog impairment conditioning (such as correcting for I/Q imbalance), and by applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with a demultiplexer that demultiplexes the modulated symbols when multiple spatial streams or space-time streams are received. The demultiplexed symbols may be provided to a demodulator, which is configured to extract the symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits may then be descrambled and provided to the MAC layer (the processor 504) for processing, evaluation or interpretation.

The radio 506 generally includes at least one radio frequency (RF) transmitter (or “transmitter chain”) and at least one RF receiver (or “receiver chain”), which may be combined into one or more transceivers. For example, each of the RF transmitters and receivers may include various analog circuitry including at least one power amplifier (PA) and at least one low-noise amplifier (LNA), respectively. The RF transmitters and receivers may, in turn, be coupled to one or more antennas. For example, in some implementations, the wireless communication device 500 can include, or be coupled with, multiple transmit antennas (each with a corresponding transmit chain) and multiple receive antennas (each with a corresponding receive chain). The symbols output from the modem 502 are provided to the radio 506, which then transmits the symbols via the coupled antennas. Similarly, symbols received via the antennas are obtained by the radio 506, which then provides the symbols to the modem 502.

The processor 504 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 504 processes information received through the radio 506 and the modem 502, and processes information to be output through the modem 502 and the radio 506 for transmission through the wireless medium. For example, the processor 504 may implement a control plane and at least a portion of a MAC layer configured to perform various operations related to the generation, transmission, reception and processing of MPDUs, frames or packets. In some implementations, the MAC layer is configured to generate MPDUs for provision to the PHY layer for coding, and to receive decoded information bits from the PHY layer for processing as MPDUs. The MAC layer may further be configured to allocate time and frequency resources, for example, for OFDMA, among other operations or techniques. In some implementations, the processor 504 may generally control the modem 502 to cause the modem to perform various operations described above.

The memory 508 can include tangible storage media such as random-access memory (RAM) or read-only memory (ROM), or combinations thereof. The memory 508 also can store non-transitory processor- or computer-executable software (SW) code containing instructions that, when executed by the processor 504, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

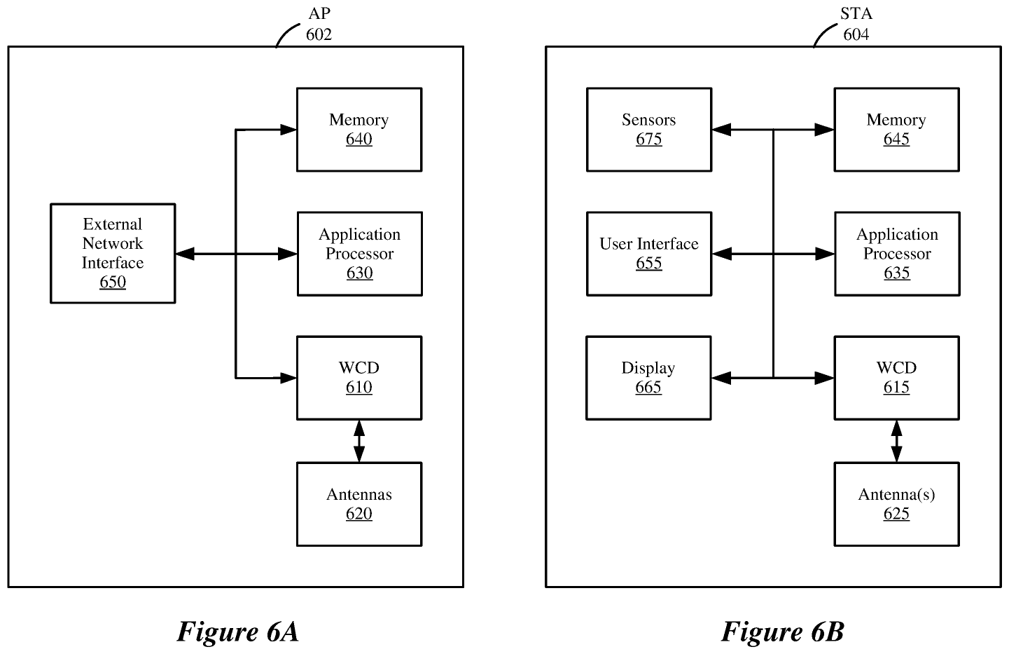

FIG. 6A shows a block diagram of an example AP 602. For example, the AP 602 can be an example implementation of the AP 102 described with reference to FIG. 1. The AP 602 includes a wireless communication device (WCD) 610 (although the AP 602 may itself also be referred to generally as a wireless communication device as used herein). For example, the wireless communication device 610 may be an example implementation of the wireless communication device 500 described with reference to FIG. 5. The AP 602 also includes multiple antennas 620 coupled with the wireless communication device 610 to transmit and receive wireless communications. In some implementations, the AP 602 additionally includes an application processor 630 coupled with the wireless communication device 610, and a memory 640 coupled with the application processor 630. The AP 602 further includes at least one external network interface 650 that enables the AP 602 to communicate with a core network or backhaul network to gain access to external networks including the Internet. For example, the external network interface 650 may include one or both of a wired (for example, Ethernet) network interface and a wireless network interface (such as a WWAN interface). Ones of the aforementioned components can communicate with other ones of the components directly or indirectly, over at least one bus. The AP 602 further includes a housing that encompasses the wireless communication device 610, the application processor 630, the memory 640, and at least portions of the antennas 620 and external network interface 650.

FIG. 6B shows a block diagram of an example STA 604. For example, the STA 604 can be an example implementation of the STA 104 described with reference to FIG. 1. The STA 604 includes a wireless communication device 615 (although the STA 604 may itself also be referred to generally as a wireless communication device as used herein). For example, the wireless communication device 615 may be an example implementation of the wireless communication device 500 described with reference to FIG. 5. The STA 604 also includes one or more antennas 625 coupled with the wireless communication device 615 to transmit and receive wireless communications. The STA 604 additionally includes an application processor 635 coupled with the wireless communication device 615, and a memory 645 coupled with the application processor 635. In some implementations, the STA 604 further includes a user interface (UI) 655 (such as a touchscreen or keypad) and a display 665, which may be integrated with the UI 655 to form a touchscreen display. In some implementations, the STA 604 may further include one or more sensors 675 such as, for example, one or more inertial sensors, accelerometers, temperature sensors, pressure sensors, or altitude sensors. Ones of the aforementioned components can communicate with other ones of the components directly or indirectly, over at least one bus. The STA 604 further includes a housing that encompasses the wireless communication device 615, the application processor 635, the memory 645, and at least portions of the antennas 625, UI 655, and display 665.

As described above, conventional SR techniques typically only consider whether the energy associated with OBSS packets detected in a particular BSS is below an OBSS PD threshold level when determining whether to allow SR transmissions in the particular BSS. Due to various network conditions (such as the number of wireless communication devices sharing the wireless medium, an amount of traffic or congestion on the wireless medium, or the proximity of the wireless communication devices to one another), these conventional SR techniques may allow SR packet transmissions that interfere with the OBSS packets (resulting in false positives), may prevent SR packet transmissions even when the SR packet transmissions would not interfere with the OBSS packets (resulting in false negatives), or both.

Various implementations of the subject matter disclosed herein relate to dynamically enabling or disabling SR transmissions from wireless communication devices in a BSS based on one or more factors that conventional SR techniques ignore. In some implementations, SR transmissions from wireless communication devices associated with the BSS may be allowed when the SINR between an average power level of intra-BSS packets received over a wireless medium and a maximum power level of OBSS packets detected on the wireless medium is greater than a value, and may not be allowed when the determined SINR is less than the value. In some other implementations, SR transmissions from wireless communication devices associated with the BSS may be allowed when the PER of ACK or BA frames received over the wireless medium is less than a value, and may not be allowed when the determined PER is greater than the value. By selectively allowing SR transmissions in the BSS based on the SINR of intra-BSS packets received over the wireless medium or based on the PER of ACK or BA frames received over the wireless medium, implementations of the subject matter disclosed herein may improve network throughput and medium utilization while eliminating or mitigating the occurrences of false positives or false negatives, for example, as compared with conventional SR techniques.

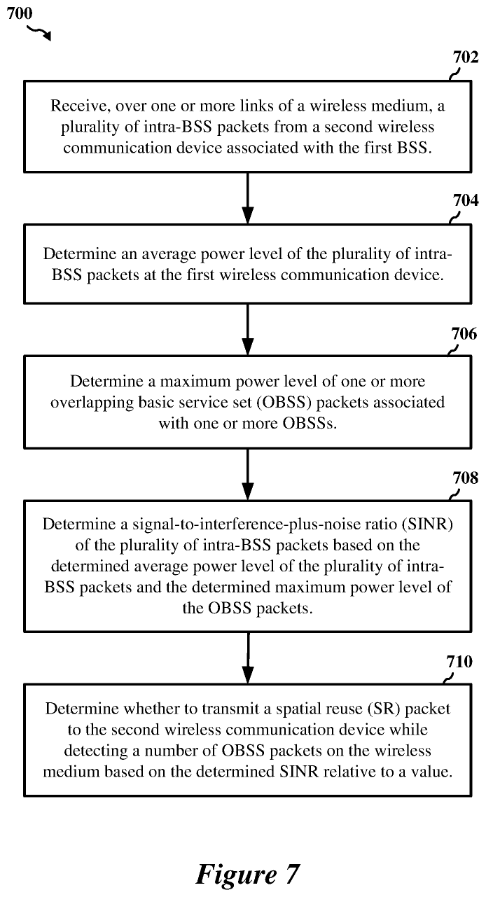

FIG. 7 shows a flowchart illustrating an example operation 700 for wireless communication according to some implementations. The operation 700 may be performed by an apparatus of a wireless communication device operating as or within an AP, such as one of the APs 102 and 602 described above with reference to FIGS. 1 and 6A, respectively. In some other implementations, the operation 700 may be performed by another suitable wireless communication device. In the example operation 700 of FIG. 7, the first wireless communication device may be associated with or belong to a first BSS.

At block 702, the first wireless communication device receives, over one or more links of a wireless medium, a plurality of intra-BSS packets from a second wireless communication device associated with the first BSS. At block 704, the first wireless communication device determines an average power level of the plurality of intra-BSS packets at the first wireless communication device. At block 706, the first wireless communication device determines a maximum power level of one or more OBSS packets associated with one or more OBSSs. At block 708, the first wireless communication device determines an SINR of the plurality of intra-BSS packets based on the determined average power level of the plurality of intra-B SS packets and the determined maximum power level of the OBSS packets. At block 710, the first wireless communication device determines whether to transmit an SR packet to the second wireless communication device while detecting a number of OBSS packets on the wireless medium based on the determined SINR relative to a value. In some instances, the determination whether to transmit the SR packet may be independent of an OBSS PD threshold.

In some implementations, one or more of the intra-BSS packets received from the second wireless communication device may be ACK frames or BA frames. For example, each of the BA frames may acknowledge reception of one or more MPDUs in a PPDU transmitted to the second wireless communication device. In some instances, the first wireless communication device may receive ACK or BA frames from one or more other wireless communication devices associated with the first BSS, and may determine the SINR of the ACK or BA frames received from the one or more other wireless communication devices.

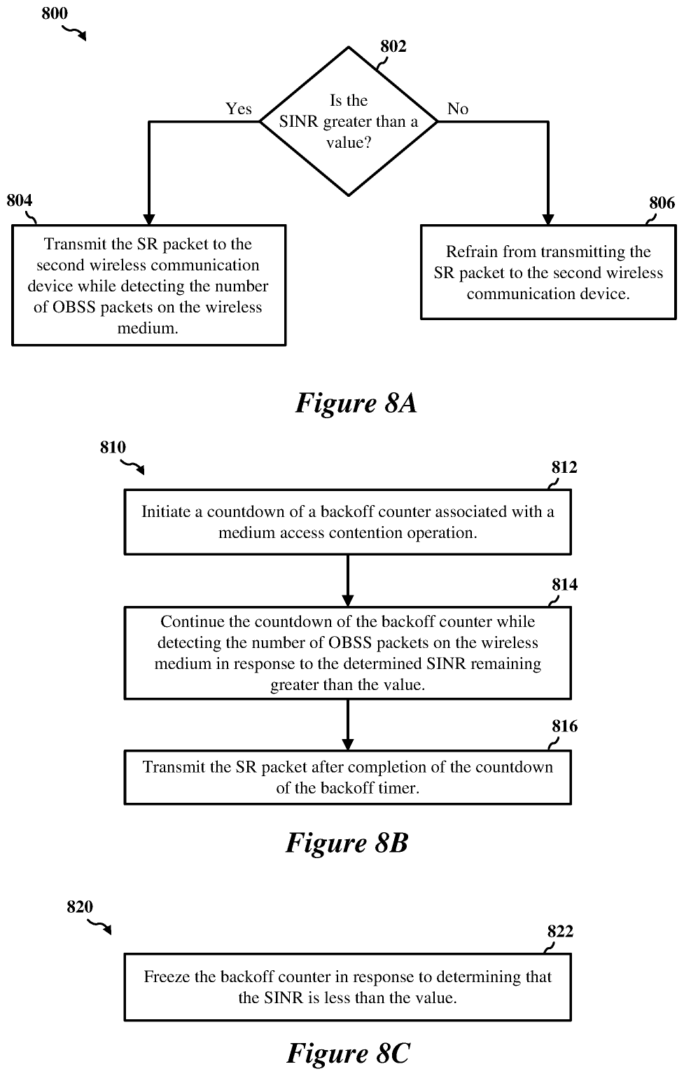

FIG. 8A shows a flowchart illustrating an example operation 800 for wireless communication according to some implementations. The operation 800 may be performed by an apparatus of a wireless communication device such as the wireless communication device 500 described above with reference to FIG. 5. In some implementations, the operation 800 may be performed by an apparatus of a first wireless communication device operating as or within an AP, such as one of the APs 102 and 602 described above with reference to FIGS. 1 and 6A, respectively. In some other implementations, the operation 800 may be performed by another suitable wireless communication device.

In some instances, the operation 800 may be an example of determining whether to transmit the SR packet in block 710 of FIG. 7. For example, at block 802, the first wireless communication device determines whether the SINR is greater than a value. If the first wireless communication device determines that the SINR is greater than the value, then, at block 804, the first wireless communication device transmits an SR packet to the second wireless communication device while detecting the number of OBSS packets on the wireless medium. Conversely, if the first wireless communication device determines that the SINR is less than the value, then, at block 806, the first wireless communication device refrains from transmitting the SR packet to the second wireless communication device.

FIG. 8B shows a flowchart illustrating an example operation 810 for wireless communication according to some implementations. The operation 810 may be performed by an apparatus of a wireless communication device such as the wireless communication device 500 described above with reference to FIG. 5. In some implementations, the operation 810 may be performed by a first wireless communication device operating as or within an AP, such as one of the APs 102 and 602 described above with reference to FIGS. 1 and 6A, respectively. In some other implementations, the operation 810 may be performed by another suitable wireless communication device.

In some instances, the operation 810 may be performed after determining that the SINR is greater than the value in block 802 of FIG. 8A. For example, at block 812, the first wireless communication device initiates a countdown of a backoff counter associated with a medium access contention operation. In some instances, the first wireless communication device may initiate the countdown of the backoff counter by selecting a random back-off number and commencing countdown of the back-off counter from the random back-off number. At block 814, while detecting the number of OBSS packets on the wireless medium, the first wireless communication device continues the countdown of the backoff counter in response to the determined SINR remaining greater than the value. At block 816, the first wireless communication device transmits the SR packet after completion of the countdown of the backoff counter.

FIG. 8C shows a flowchart illustrating an example operation 820 for wireless communication according to some implementations. The operation 820 may be performed by an apparatus of a wireless communication device such as the wireless communication device 500 described above with reference to FIG. 5. In some implementations, the operation 820 may be performed by a first wireless communication device operating as or within an AP, such as one of the APs 102 and 602 described above with reference to FIGS. 1 and 6A, respectively. In some other implementations, the operation 820 may be performed by another suitable wireless communication device.

In some instances, the operation 820 may be performed at any time during the operation 810 of FIG. 8B. For example, at block 822, the first wireless communication device freezes the backoff counter in response to determining that the SINR is less than the value. In addition, or in the alternative, the first wireless communication device may reset the backoff counter in response to determining that the SINR is less than the value. In this way, the first wireless communication device may either pause or restart the medium access contention operation when transmission of the SR packet is likely to interfere with the number of OBSS packets.

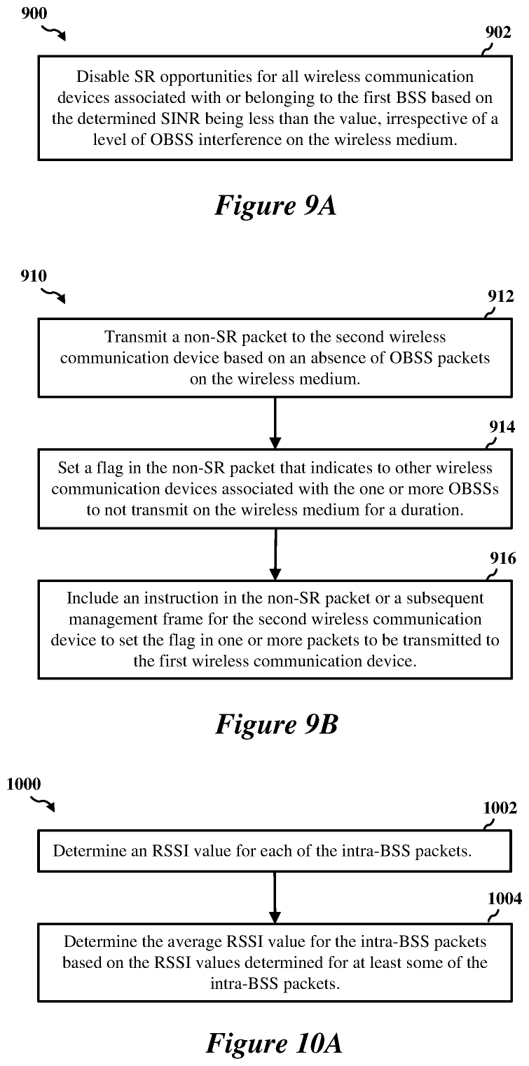

FIG. 9A shows a flowchart illustrating an example operation 900 for wireless communication according to some implementations. The operation 900 may be performed by an apparatus of a wireless communication device such as the wireless communication device 500 described above with reference to FIG. 5. In some implementations, the operation 900 may be performed by an apparatus of a first wireless communication device operating as or within an AP, such as one of the APs 102 and 602 described above with reference to FIGS. 1 and 6A, respectively. In some other implementations, the operation 900 may be performed by another suitable wireless communication device.

In some instances, the operation 900 may be performed after the operation 700 of FIG. 7. For example, at block 902, the first wireless communication device disables SR opportunities for all wireless communication devices associated with or belonging to the first BSS based on the determined SINR being less than the value, irrespective of a level of OBSS interference on the wireless medium. In this way, the first wireless communication device may prevent the transmission of SR packets from interfering with the OBSS packets, regardless of whether the energy associated with the OBSS packets is less than an OBSS PD threshold. Disabling SR opportunities for all wireless communication devices associated with or belonging to the first BSS also may allow the wireless communication devices to continue transmitting intra-BSS packets at full power, for example, rather than at reduced power levels specified for SR opportunities by the IEEE 802.11 family of standards.

FIG. 9B shows a flowchart illustrating an example operation 910 for wireless communication according to some implementations. The operation 910 may be performed by an apparatus of a wireless communication device such as the wireless communication device 500 described above with reference to FIG. 5. In some implementations, the operation 910 may be performed by a first wireless communication device operating as or within an AP, such as one of the APs 102 and 602 described above with reference to FIGS. 1 and 6A, respectively. In some other implementations, the operation 910 may be performed by another suitable wireless communication device.

In some instances, the operation 910 may be performed after the operation 700 of FIG. 7. For example, at block 912, the first wireless communication device may transmit a non-SR packet to the second wireless communication device based on an absence of OBSS packets on the wireless medium. At block 914, the first wireless communication device may set a flag in the non-SR packet that indicates to other wireless communication devices associated with the one or more OBSSs to not transmit on the wireless medium for a duration. At block 916, first wireless communication device may include an instruction in the non-SR packet or in a subsequent management frame for the second wireless communication device to set the flag in one or more packets to be transmitted from the second wireless communication device to the first wireless communication device on the wireless medium.

In some implementations, the first wireless communication device may continue to monitor the wireless medium for a presence of OBSS packets during the operation 910. In addition, or in the alternative, the first wireless communication device may determine whether to include the instruction in the non-SR packet irrespective of whether the first wireless communication device set the flag in the non-SR packet.

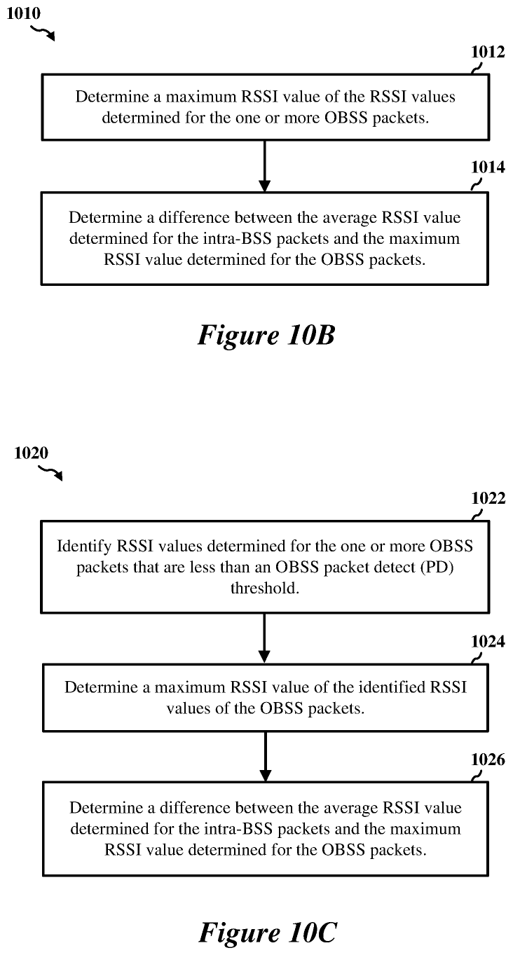

FIG. 10A shows a flowchart illustrating an example operation 1000 for wireless communication according to some implementations. The operation 1000 may be performed by an apparatus of a wireless communication device such as the wireless communication device 500 described above with reference to FIG. 5. In some implementations, the operation 1000 may be performed by a first wireless communication device operating as or within an AP, such as one of the APs 102 and 602 described above with reference to FIGS. 1 and 6A, respectively. In some other implementations, the operation 1000 may be performed by another suitable wireless communication device.

In some instances, the operation 1000 may be an example of determining the average power level of the intra-BSS packets in block 704 of FIG. 7. For example, at block 1002, the first wireless communication device determines an RSSI value for each packet of the plurality of intra-BSS packets. At block 1004, the first wireless communication device determines the average RSSI value for the intra-BSS packets based on the RSSI values determined for at least some of the plurality of intra-BSS packets.

FIG. 10B shows a flowchart illustrating an example operation 1010 for wireless communication according to some implementations. The operation 1010 may be performed by an apparatus of a wireless communication device such as the wireless communication device 500 described above with reference to FIG. 5. In some implementations, the operation 1010 may be performed by a first wireless communication device operating as or within an AP, such as one of the APs 102 and 602 described above with reference to FIGS. 1 and 6A, respectively. In some other implementations, the operation 1010 may be performed by another suitable wireless communication device.

In some instances, the operation 1010 may be an example of determining the SINR in block 708 of FIG. 7. For example, at block 1012, the first wireless communication device determines a maximum RSSI value of the RSSI values determined for the one or more OBSS packets. At block 1014, the first wireless communication device determines a difference between the average RSSI value determined for the intra-BSS packets and the maximum RSSI value determined for the OBSS packets. In some implementations, the maximum RSSI value may be the highest of the RSSI values for the OBSS packets received at the first wireless communication device during a measurement window. In some instances, the measurement window may be between approximately 5 seconds and 10 seconds. In some other instances, the measurement window may be of another suitable duration, such as between approximately 1 seconds and 30 seconds.

FIG. 10C shows a flowchart illustrating an example operation 1020 for wireless communication according to some implementations. The operation 1020 may be performed by an apparatus of a wireless communication device such as the wireless communication device 500 described above with reference to FIG. 5. In some implementations, the operation 1020 may be performed by a first wireless communication device operating as or within an AP, such as one of the APs 102 and 602 described above with reference to FIGS. 1 and 6A, respectively. In some other implementations, the operation 1020 may be performed by another suitable wireless communication device.

In some instances, the operation 1020 may be another example of determining the SINR in block 708 of FIG. 7. For example, at block 1022, the first wireless communication device identifies RSSI values determined for the one or more OBSS packets that are less than an OBSS PD threshold. In some instances, the OBSS PD threshold may be approximately −62 dBm. At block 1024, the first wireless communication device determines a maximum RSSI value of the identified RSSI values of the OBSS packets. In some implementations, the identified RSSI values may correspond to OBSS packets detected at the first wireless communication device during a measurement window. In some instances, the measurement window may be between approximately 5 seconds and 10 seconds. In some other instances, the measurement window may be of another suitable duration, such as between approximately 1 seconds and 30 seconds. At block 1026, the first wireless communication device determines a difference between the average RSSI value determined for the intra-BSS packets and the maximum RSSI value determined for the OBSS packets.

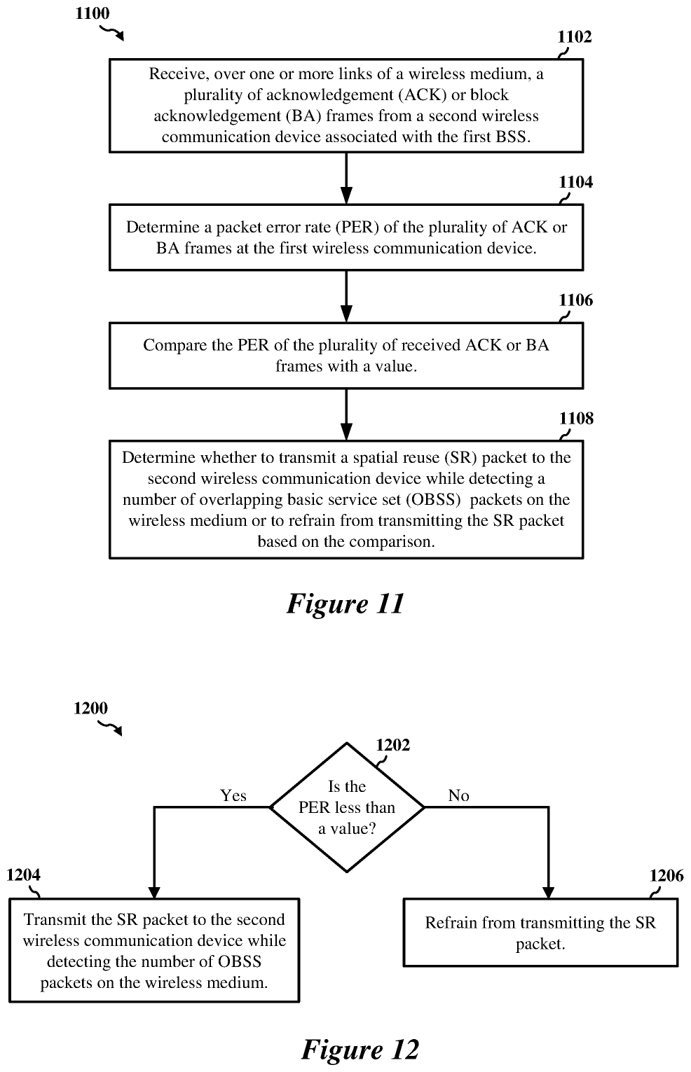

FIG. 11 shows a flowchart illustrating an example operation 1100 for wireless communication according to some implementations. The operation 1100 may be performed by an apparatus of a wireless communication device operating as or within an AP, such as one of the APs 102 and 602 described above with reference to FIGS. 1 and 6A, respectively. In some other implementations, the operation 1100 may be performed by another suitable wireless communication device. In the example operation 1100 of FIG. 11, the first wireless communication device may be associated with or belong to a first BSS.

At block 1102, the first wireless communication device receives, over one or more links of a wireless medium, a plurality of acknowledgement (ACK) or block acknowledgement (BA) frames from a second wireless communication device associated with the first BSS. At block 1104, the first wireless communication device determines a packet error rate (PER) of the plurality of ACK or BA frames at the first wireless communication device. At block 1106, the first wireless communication device compares the determined PER of the plurality of ACK or BA frames with a value. At block 1108, the first wireless communication device determines whether to transmit an SR packet to the second wireless communication device while detecting a number of OBSS packets on the wireless medium based on the comparison. In some instances, the determination whether to transmit the SR packet may be independent of an OBSS PD threshold.

FIG. 12 shows a flowchart illustrating an example operation 1200 for wireless communication according to some implementations. The operation 1200 may be performed by an apparatus of a wireless communication device such as the wireless communication device 500 described above with reference to FIG. 5. In some implementations, the operation 1200 may be performed by an apparatus of a first wireless communication device operating as or within an AP, such as one of the APs 102 and 602 described above with reference to FIGS. 1 and 6A, respectively. In some other implementations, the operation 1200 may be performed by another suitable wireless communication device.

In some instances, the operation 1200 may be an example of determining whether to transmit the SR packet in block 1108 of FIG. 11. For example, at block 1202, the first wireless communication device determines whether the PER of the plurality of ACK or BA frames is less than a value. If the first wireless communication device determines that the PER of the plurality of ACK or BA frames is less than the value, then, at block 1204, the first wireless communication device transmits an SR packet to the second wireless communication device while detecting the number of OBSS packets on the wireless medium. Conversely, if the first wireless communication device determines that the PER of the plurality of ACK or BA frames is greater than the value, then, at block 1206, the first wireless communication device refrains from transmitting the SR packet to the second wireless communication device.

In some other implementations, the first wireless communication device may determine the number of ACK timeouts during a measurement window, may compare the determined number of ACK timeouts with a value, and may determine whether to transmit an SR packet to the second wireless communication device while detecting a number of OBSS packets on the wireless medium based on the comparison. In some instances, the first wireless communication device may transmit an SR packet to the second wireless communication device while detecting the number of OBSS packets on the wireless medium based on the determined number of ACK timeouts being less than the value, or may refrain from transmitting the SR packet to the second wireless communication device while detecting the number of OBSS packets on the wireless medium based on the determined number of ACK timeouts being greater than the value.

In some other implementations, the first wireless communication device may determine the throughput loss of intra-BSS packets transmitted on the wireless medium, may compare the determined throughput loss with a value, and may determine whether to transmit an SR packet to the second wireless communication device while detecting a number of OBSS packets on the wireless medium based on the comparison. In some instances, the first wireless communication device may transmit an SR packet to the second wireless communication device while detecting the number of OBSS packets on the wireless medium based on the determined throughput loss being less than the value, or may refrain from transmitting the SR packet to the second wireless communication device while detecting the number of OBSS packets on the wireless medium based on the determined throughput loss being greater than the value.

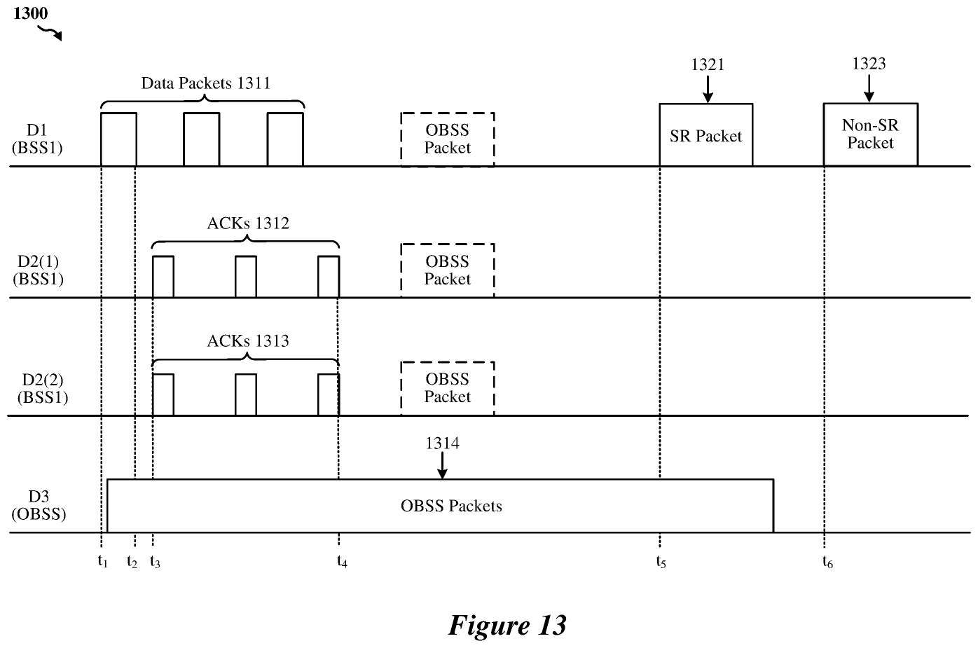

FIG. 13 shows a timing diagram 1300 illustrating the transmissions of communications according to some implementations. The communications may relate to transmissions of spatial reuse (SR) packets by a first wireless communication device D1 associated with a first BSS (BSS1) to one or more second wireless communication devices D2(1) and D2(2) belonging to BSS1. A third wireless communication device D3 may belong to an OBSS. Each of the wireless communication devices D1, D2(1), D2(2), and D3 may be any suitable wireless communication device such as one of the APs 102 and 602 described above with reference to FIGS. 1 and 6A, respectively, or one of the STAs 104 and 604 described above with reference to FIGS. 1 and 6B, respectively. In some implementations, device D1 may be an AP that manages BSS1, devices D2(1) and D2(2) may be two example STAs associated with BSS1, and device D3 may be a STA associated with another AP (not shown for simplicity) that manages the OBSS. In some other instances, device D3 may be an AP associated with the OBSS.

Prior to time t₁, device D1 may obtain a TXOP for transmissions over a wireless medium by contending with other wireless communication devices (such as devices D2(1) and D2(2)). In some implementations, device D1 and the other wireless communication devices may contend for medium access using a Distributed Coordination Function (DCF). As described above, the DCF may be implemented through the use of CSMA/CA and timing intervals (such as SIFS, DIFS, EIFS, and AIFS). For example, device D1 senses the wireless medium, and after the wireless medium remains idle for the appropriate IFS (for example, the DIFS), device D1 begins to decrement its back-off counter from a randomly selected value between 0 and CW, where CW is a contention window size. Other contending wireless communication devices such as devices D2(1) and D2(2) follow a similar procedure and randomly select initial values for their own back-off counters. Each of the wireless communication devices D1, D2(1), and D2(2) decrements its back-off counter by one slot each time the medium is sensed to be idle during a corresponding slot interval. For the example of FIG. 13, device D1 selected the lowest back-off value such that its back-off counter reaches zero before the back-off counters associated with devices D2(1) and D2(2), and thus, device D1 wins access to the wireless medium and obtains (and becomes the owner of) the TXOP.

Beginning at time t₁, device D1 transmits a plurality of data packets 1311 to devices D2(1) and D2(2) over the wireless medium. Devices D2(1) and D2(2) receive the data packets 1311 at time t₂, and acknowledge receipt of the data packets 1311 by transmitting respective ACK frames 1312 and 1313 to device D1 beginning at time t₃. In some other instances, devices D2(1) and D2(2) may transmit block acknowledgement (BA) frames to acknowledge receipt of the data packets 1311. The data packets 1311 and the ACK or BA frames 1312-1313 are transmitted between wireless communication devices belonging to the same BSS (BSS1), and may be referred to herein as intra-BSS packets.

After time t₁, device D3 may transmit one or more packets 1314 to wireless communication devices associated with the OBSS. The one or more packets 1314, denoted herein as OBSS packets 1314, may cause interference at device D1, may interfere with transmission of the data packets 1311, may interfere with the transmission of ACK frames 1312 and 1313, or any combination thereof. Device D1 may detect the one or more OBSS packets 1314 on the wireless medium using any suitable technique (such as carrier sensing or energy detection).

Device D1 may determine an average power level of the intra-BSS packets transmitted over the wireless medium between times t₁ and t₄. In some implementations, the intra-BSS packets for which device D1 measures or determines the average power level may be the received ACK or BA frames 1312 and 1313. In other implementations, the intra-BSS packets for which device D1 measures or determines the average power level may be the data packets 1311. In some other implementations, the intra-BSS packets for which device D1 measures or determines the average power level may be the data packets 1311 and the received ACK or BA frames 1312 and 1313. In some instances, device D1 may determine the average power level of the intra-BSS packets by measuring or determining an RSSI value for each of the intra-BSS packets, and may use the RSSI values of at least some of the intra-BSS packets to determine the average RSSI value. For example, device D1 may determine an RSSI value for each of the ACK or BA frames 1312 and 1313 received from respective devices D2(1) and D2(2), and may determine an average RSSI value for the ACK or BA frames 1312 and 1313 based on one or more of the determined RSSI values.

Device D1 also may determine an SINR of the intra-BSS packets based on the average power level of the intra-BSS packets and a maximum power level of the OBSS packets 1314. In some instances, device D1 may measure or determine an RSSI value for each of the OBSS packets 1314, identify which of the measured RSSI values is the greatest, and use the identified RSSI value as the maximum RSSI value of the OBSS packets 1314. In some implementations, device D1 may determine the SINR of the intra-BSS packets by determining a difference between the average RSSI value of the intra-BSS packets and the maximum RSSI value of the OBSS packets 1314 during a measurement window. In some other implementations, device D1 may determine the SINR of the intra-BSS packets by identifying RSSI values of the OBSS packets 1314 that are less than an OBSS PD threshold, determining a maximum RSSI value of the identified RSSI values of the OBSS packets 1314, and determining a difference between the average RSSI value of the intra-BSS packets and the maximum RSSI value of the OBSS packets 1314. In some aspects, device D1 may periodically repeat the measurement window (and the determinations therein) so that device D1 can dynamically enable SR opportunities or disable SR opportunities based on changes in network conditions.

In some aspects, device D1 may determine the average received power of the ACK or BA frames 1312 and 1313 according to Equations (1)-(4) below.

$$\begin{matrix} a = \frac{{I}_{O B S S}}{N} & ( 1 ) \\ b = \frac{( {S}_{A C K} + {I}_{O B S S} )}{N} & ( 2 ) \\ ( b - a ) ( d B ) = {S}_{A C K} ( d B m ) - N ( dBm ) & ( 3 ) \\ Average ACK Rx power ( dBm ) = {S}_{A C K} ( d B m ) = ( b - a ) ( d B ) + N ( d B m ) & ( 4 )\end{matrix}$$

In Equations (1)-(4), a represents an average RSSI for the OBSS packets 1314, b represents an average RSSI for the ACK or BA frames 1312 and 1313, I_{OBSS} represents the maximum power of the OBSS packets 1314, N represents a noise power, and S_{ACK} represents the received power of the ACK or BA frames 1312 and 1313.

In some aspects, device D1 may determine the maximum power of the OBSS packets 1314 according to Equations (5)-(6) below.

Max_OBSS_RSSI (dB)=Max OBSS interference (dBm)−NF (dBm) (5)

Max OBSS interference (dBm)=Max_OBSS_RSSI (dB)+NF (dBm) (6)

In Equations (5) and (6), Max_OBSS_RSSI represents a maximum RSSI value for the OBSS packets 1314 over the measurement window, and NF represents the noise floor.

At time t₅, device D1 may transmit a spatial reuse (SR) packet 1321 to devices D2(1) and D2(2) in response to the SINR of the intra-BSS packets being greater than a value, even while continuing to detect the OBSS packets 1314 on the wireless medium. Otherwise, in response to the SINR of the intra-BSS packets being less than the value, device D1 may refrain from transmitting the SR packet 1321 to devices D2(1) and D2(2). In some implementations, transmission of the SR packet 1321 may at least partially overlap with the transmission of at least one of the OBSS packets 1314 from the OBSS.

In implementations for which device D1 did not obtain a TXOP, or in implementations for which the TXOP obtained by device D1 has expired, transmission of the SR packet 1321 may include initiating a countdown of device D1's backoff counter, continuing the countdown of the backoff counter while detecting one or more of the OBSS packets 1314 in response to the SINR of the intra-BSS packets remaining greater than the value, and transmitting the SR packet 1321 after completion of the countdown of the backoff counter. In some aspects, device D1 may freeze its backoff counter in response to determining that the SINR of the intra-BSS packets is less than the value. In a non-limiting example, device D1 may determine that the backoff counter has reached a backoff counter value (such as 1) and freeze the backoff counter in response to determining that the SINR of the intra-BSS packets is less than the value. In some other aspects, device D1 may reset its backoff counter in response to determining that the SINR of the intra-BSS packets is less than the value.

In the example of FIG. 13, device D3 stops transmitting OBSS packets 1314 between times t₅ and t₆. At time t₆, device D1 transmits a non-SR packet 1323 to devices D2(1) and D2(2) based on an absence of OBSS packets 1314 detected on the wireless medium. In some implementations, device D1 may set a flag in the non-SR packet 1323 that indicates to wireless communication devices associated with the OBSS to not transmit on the wireless medium for a duration. For example, device D1 may set the flag in the non-SR packet 1323 to indicate to device D3 to not transmit during transmission of the non-SR packet 1323. Device D1 also may include an instruction in the non-SR packet 1323, or in one or more subsequent management frames, for devices D2(1) and D2(2) to set flags in one or more packets subsequently transmitted from respective devices D2(1) and D2(2).

In some other implementations, device D1 may determine a packet error rate (PER) of the ACK or BA frames 1312 or 1313 received at device D1, may compare the determined PER of the ACK or BA frames 1312 or 1313 with a value, and may determine whether to transmit the SR packet 1321 to one or more of the devices D2(1) and D2(2) while detecting OBSS packets on the wireless medium based on the comparison. In some instances, device D1 may transmit the SR packet 1321 to the one or more devices D2(1) and D2(2) while detecting OBSS packets on the wireless medium based on the determined PER of the ACK or BA frames 1312 or 1313 being less than the value, or may refrain from transmitting the SR packet 1321 to the one or more devices D2(1) and D2(2) while detecting OBSS packets on the wireless medium based on the determined PER of the ACK or BA frames 1312 or 1313 being greater than the value. In this way, the determination whether to transmit the SR packet 1321 to the one or more devices D2(1) and D2(2) while detecting OBSS packets on the wireless medium is independent of the OBSS PD threshold.

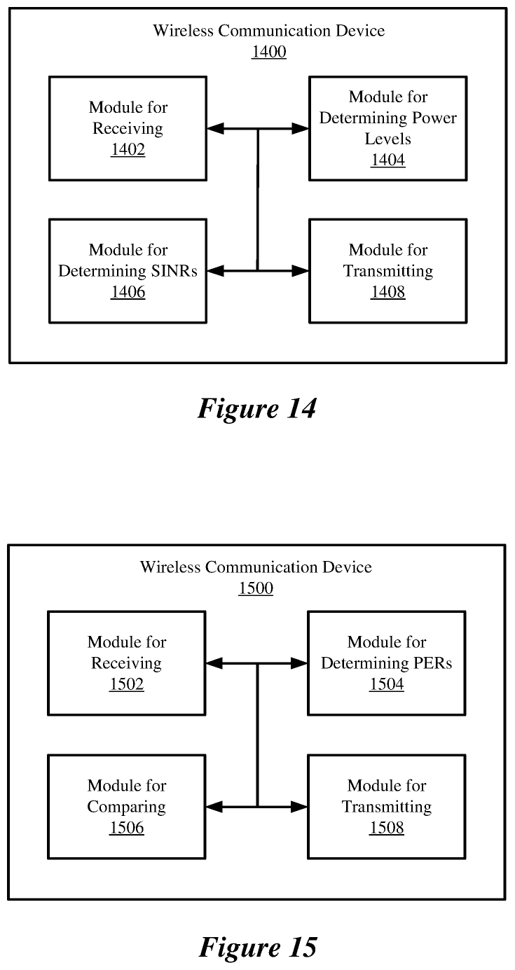

FIG. 14 shows a block diagram of an example wireless communication device 1400 according to some implementations. In some implementations, the wireless communication device 1400 is configured to perform one or more of the operations described above. The wireless communication device 1400 may be an example implementation of the wireless communication device 500 described above with reference to FIG. 5. For example, the wireless communication device 1400 can be a chip, SoC, chipset, package, or device that includes at least one processor and at least one modem (for example, a Wi-Fi (IEEE 802.11) modem or a cellular modem). In some implementations, the wireless communication device 1400 can be a device for use in an AP, such as one of the APs 102 and 602 described above with reference to FIGS. 1 and 6A, respectively. In some other implementations, the wireless communication device 1400 can be an AP that includes such a chip, SoC, chipset, package, or device as well as at least one transmitter, at least one receiver, and at least one antenna.

The wireless communication device 1400 includes a module for receiving 1402, a module for determining power levels 1404, a module for determining SINRs, and a module for transmitting 1408. Portions of one or more of the modules 1402, 1404, 1406, and 1408 may be implemented at least in part in hardware or firmware. For example, the module for receiving packets 1402 may be implemented at least in part by a modem (such as the modem 502). In some implementations, at least some of the modules 1402, 1404, 1406, and 1408 are implemented at least in part as software stored in a memory (such as the memory 508). For example, portions of one or more of the modules 1402, 1404, 1406, and 1408 can be implemented as non-transitory instructions (or “code”) executable by a processor (such as the processor 506) to perform the functions or operations of the respective module.

The wireless communication device 1400 is associated with a first BSS. The module for receiving packets 1402 is configured to receive intra-BSS packets from a second wireless communication device associated with the first BSS. The module for determining power levels 1404 is configured to determine an average power level of the intra-BSS packets, and to determine a maximum power level of one or more OBSS packets associated with one or more OBSSs. The module for determining SINRs 1406 is configured to determine the SINR of the received intra-BSS packets based on the determined average power level of the intra-BSS packets and the determined maximum power level of the OBSS packets. The module for transmitting 1408 is configured to determine whether to transmit an SR packet to other wireless communication devices belonging to the same BSS as the wireless communication device 1500 based on the determined SINR relative to a value.

FIG. 15 shows a block diagram of an example wireless communication device 1500 according to some implementations. In some implementations, the wireless communication device 1500 is configured to perform one or more of the operations described above. The wireless communication device 1500 may be an example implementation of the wireless communication device 500 described above with reference to FIG. 5. For example, the wireless communication device 1500 can be a chip, SoC, chipset, package, or device that includes at least one processor and at least one modem (for example, a Wi-Fi (IEEE 802.11) modem or a cellular modem). In some implementations, the wireless communication device 1500 can be a device for use in an AP, such as one of the APs 102 and 602 described above with reference to FIGS. 1 and 6A, respectively. In some other implementations, the wireless communication device 1500 can be an AP that includes such a chip, SoC, chipset, package, or device as well as at least one transmitter, at least one receiver, and at least one antenna.

The wireless communication device 1500 includes a module for receiving 1502, a module for determining PERs 1504, a module for comparing 1506, and a module for transmitting 1508. Portions of one or more of the modules 1502, 1504, 1506, and 1508 may be implemented at least in part in hardware or firmware. For example, the module for receiving and detecting packets 1502 may be implemented at least in part by a modem (such as the modem 502). In some implementations, at least some of the modules 1502, 1504, 1506, and 1508 are implemented at least in part as software stored in a memory (such as the memory 508). For example, portions of one or more of the modules 1502, 1504, 1506, and 1508 can be implemented as non-transitory instructions (or “code”) executable by a processor (such as the processor 506) to perform the functions or operations of the respective module.

The wireless communication device 1500 is associated with a first BSS. The module for receiving 1502 is configured to receive packets transmitted by a second wireless communication device associated with the first BSS. The module for determining PERs 1504 is configured to determine a PER of ACK or BA frames intended for the wireless communication device 1500. The module for comparing 1506 is configured to compare the PERs of the received ACK or BA frames with a value. The module for transmitting 1508 is configured to determine whether to transmit a SR packet to other wireless communication devices belonging to the same BSS as the wireless communication device 1500 based on the comparison.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method performed by an apparatus of a first wireless communication device associated with a first basic service set (BSS), comprising:
receiving, over one or more links of a wireless medium, a plurality of intra-BSS packets from a second wireless communication device associated with the first BSS;
determining an average power level of the plurality of intra-BSS packets at the first wireless communication device;
determining a maximum power level of one or more overlapping basic service set (OBSS) packets associated with one or more OBSSs;
determining a signal-to-interference-plus-noise ratio (SINR) of the plurality of intra-BSS packets based on the determined average power level of the plurality of intra-BSS packets and the determined maximum power level of the OBSS packets; and
determining whether to transmit a spatial reuse (SR) packet to the second wireless communication device while detecting a number of OBSS packets on the wireless medium based on the determined SINR relative to a value.

2. The method of claim 1, wherein the determination whether to transmit the SR packet is independent of an OBSS packet detect (PD) threshold.

3. The method of claim 1, wherein determining whether to transmit the SR packet comprises:
transmitting the SR packet to the second wireless communication device while detecting the number of OBSS packets on the wireless medium based on the determined SINR being greater than the value.

4. The method of claim 3, wherein the transmission of the SR packet at least partially overlaps with the transmission of at least one of the number of OBSS packets.

5. The method of claim 3, wherein the transmission of the SR packet comprises:
initiating a countdown of a backoff counter associated with a medium access contention operation;
continuing the countdown of the backoff counter while detecting the number of OBSS packets on the wireless medium in response to the determined SINR remaining greater than the value; and
transmitting the SR packet after completion of the countdown of the backoff counter.

6. (canceled)

7. The method of claim 1, wherein determining whether to transmit the SR packet comprises:
refraining from transmitting the SR packet to the second wireless communication device based on the determined SINR being less than the value.

8. The method of claim 1, further comprising:
disabling SR opportunities for all wireless communication devices associated with or belonging to the first BSS based on the determined SINR being less than the value, irrespective of a level of OBSS interference on the wireless medium.

9. The method of claim 1, further comprising:
transmitting a non-SR packet to the second wireless communication device based on an absence of OBSS packets on the wireless medium; and
setting a flag in the non-SR packet that indicates to other wireless communication devices associated with the one or more OBSSs to not transmit on the wireless medium for a duration.

10. (canceled)

11. The method of claim 1, wherein one or more of the plurality of intra-BSS packets comprises an acknowledgement (ACK) frame or a block ACK (BA) frame.

12. The method of claim 1, wherein determining the average power level of the intra-BSS packets comprises:
determining a received signal strength indicator (RSSI) value for each packet of the plurality of intra-BSS packets; and
determining the average RSSI value for the intra-BSS packets based on the RSSI values determined for at least some of the plurality of intra-BSS packets.

13. The method of claim 12, wherein determining the SINR further comprises:
determining a maximum RSSI value of the RSSI values determined for the one or more OBSS packets; and
determining a difference between the average RSSI value determined for the intra-BSS packets and the maximum RSSI value determined for the OBSS packets.

14. The method of claim 12, wherein determining the SINR further comprises:
identifying RSSI values determined for the one or more OBSS packets that are less than an OBSS packet detect (PD) threshold;
determining a maximum RSSI value of the identified RSSI values of the OBSS packets; and
determining a difference between the average RSSI value determined for the intra-BSS packets and the maximum RSSI value determined for the OBSS packets.

15. A method performed by an apparatus of a first wireless communication device associated with a first basic service set (BSS), comprising:
receiving, over one or more links of a wireless medium, a plurality of acknowledgement (ACK) or block acknowledgement (BA) frames from a second wireless communication device associated with the first BSS;
determining a packet error rate (PER) of the plurality of ACK or BA frames at the first wireless communication device;
comparing the determined PER of the plurality of ACK or BA frames with a value; and
determining whether to transmit a spatial reuse (SR) packet to the second wireless communication device while detecting a number of overlapping basic service set (OBSS) packets on the wireless medium based on the comparison.

16. The method of claim 15, wherein determining whether to transmit the SR packet further comprises:
transmitting the SR packet to the second wireless communication device while detecting the number of OBSS packets on the wireless medium based on the determined PER of the plurality of ACK or BA frames being less than the value.

17. The method of claim 15, wherein determining whether to transmit the SR packet further comprises:
refraining from transmitting the SR packet to the second wireless communication device based on the determined PER of the plurality of ACK or BA frames being greater than the value.

18. A first wireless communication device associated with a first basic service set (BSS), comprising:
at least one modem;
at least one processor communicatively coupled with the at least one modem; and
at least one memory communicatively coupled with the at least one processor and storing instructions that, when executed by the at least one processor in conjunction with the at least one modem, causes the first wireless communication device to:
receive, over one or more links of a wireless medium, a plurality of intra-BSS packets from a second wireless communication device associated with the first BSS;
determine an average power level of the plurality of intra-BSS packets at the first wireless communication device;
determine a maximum power level of one or more overlapping basic service set (OBSS) packets associated with one or more OBSSs;
determine a signal-to-interference-plus-noise ratio (SINR) of the plurality of intra-BSS packets based on the determined average power level of the plurality of intra-BSS packets and the determined maximum power level of the OBSS packets; and
determine whether to transmit a spatial reuse (SR) packet to the second wireless communication device while detecting a number of OBSS packets on the wireless medium based on the determined SINR relative to a value.

19. The first wireless communication device of claim 18, wherein the determination whether to transmit the SR packet is independent of an OBSS packet detect (PD) threshold.

20. The first wireless communication device of claim 18, wherein execution of the instructions to determine whether to transmit the SR packet further causes the first wireless communication device to:
transmit the SR packet to the second wireless communication device while detecting the number of OBSS packets on the wireless medium based on the determined SINR being greater than the value.

21. The first wireless communication device of claim 20, wherein the transmission of the SR packet at least partially overlaps with the transmission of at least one of the number of OBSS packets.

22. The first wireless communication device of claim 20, wherein execution of the instructions to transmit the SR packet further causes the first wireless communication device to:
initiate a countdown of a backoff counter associated with a medium access contention operation;
continue the countdown of the backoff counter while detecting the number of OBSS packets on the wireless medium in response to the determined SINR remaining greater than the value; and
transmit the SR packet after completion of the countdown of the backoff counter.

23. (canceled)

24. The first wireless communication device of claim 18, wherein execution of the instructions to determine whether to transmit the SR packet further causes the first wireless communication device to:
refrain from transmitting the SR packet to the second wireless communication device based on the determined SINR being less than the value.

25. The first wireless communication device of claim 18, wherein execution of the instructions further causes the first wireless communication device to:
disable SR opportunities for all wireless communication devices associated with or belonging to the first BSS based on the determined SINR being less than the value, irrespective of a level of OBSS interference on the wireless medium.

26. The first wireless communication device of claim 18, wherein execution of the instructions further causes the first wireless communication device to:
transmit a non-SR packet to the second wireless communication device based on an absence of OBSS packets on the wireless medium; and
set a flag in the non-SR packet that indicates to other wireless communication devices associated with the one or more OBSSs to not transmit on the wireless medium for a duration.

27. (canceled)

28. The first wireless communication device of claim 18, wherein one or more of the plurality of intra-BSS packets comprises an acknowledgement (ACK) frame or a block ACK (BA) frame.

29. The first wireless communication device of claim 18, wherein execution of the instructions to determine the average power level of the intra-BSS packets further causes the first wireless communication device to:
determine a received signal strength indicator (RSSI) value for each packet of the plurality of intra-BSS packets; and
determine the average RSSI value for the intra-BSS packets based on the RSSI values determined for at least some of the plurality of intra-BSS packets.

30. The first wireless communication device of claim 29, wherein execution of the instructions to determine the SINR further causes the first wireless communication device to:
determine a maximum RSSI value of the RSSI values determined for the one or more OBSS packets; and
determine a difference between the average RSSI value determined for the intra-BSS packets and the maximum RSSI value determined for the OBSS packets.

31. The first wireless communication device of claim 29, wherein execution of the instructions to determine the SINR further causes the first wireless communication device to:
identify RSSI values determined for the one or more OBSS packets that are less than an OBSS packet detect (PD) threshold;
determine a maximum RSSI value of the identified RSSI values of the OBSS packets; and
determine a difference between the average RSSI value determined for the intra-BSS packets and the maximum RSSI value determined for the OBSS packets.

32. A first wireless communication device associated with a first basic service set (BSS), comprising:
at least one modem;
at least one processor communicatively coupled with the at least one modem; and
at least one memory communicatively coupled with the at least one processor and storing instructions that, when executed by the at least one processor in conjunction with the at least one modem, causes the first wireless communication device to:
receive, over one or more links of a wireless medium, a plurality of acknowledgement (ACK) or block acknowledgement (BA) frames from a second wireless communication device associated with the first BSS;
determine a packet error rate (PER) of the plurality of ACK or BA frames at the first wireless communication device;
compare the PER of the plurality of received ACK or BA frames with a value;
determine whether to transmit a spatial reuse (SR) packet to the second wireless communication device while detecting a number of overlapping basic service set (OBSS) packets on the wireless medium based on the comparison.

33. The first wireless communication device of claim 32, wherein execution of the instructions to determine whether to transmit the SR packet further causes the first wireless communication device to:
transmit the SR packet to the second wireless communication device while detecting the number of OBSS packets on the wireless medium based on the determined PER of the plurality of ACK or BA frames being less than the value.

34. The first wireless communication device of claim 32, wherein execution of the instructions to determine whether to transmit the SR packet further causes the first wireless communication device to:
refrain from transmitting the SR packet to the second wireless communication device based on the determined PER of the plurality of ACK or BA frames being greater than the value.
